(19) United States
(12) Patent Application Publication
(10) Pub. No.: US 2005/0071277 A1
(43) Pub. Date: Mar. 31, 2005

(54) Document transmission control method

(75) Inventor: Tetsuya Yokoyama, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/950,380

(22) Filed: Sep. 28, 2004

(30) Foreign Application Priority Data
Sep. 29, 2003 (JP) 2003-338297

(51) Int. Cl. G06F 17/60

(52) U.S. Cl. 705/51

(57) ABSTRACT

It is an object to attain improvements in data modification by carrying out processing in accordance with a right to transmit unprotected data when electronic data is transmitted. A document transmission control method according to the present invention includes the steps of: analyzing image data and identifying a storage location of electronic data; performing user certification; designating, after the electronic data of the document is identified, a destination to which the electronic data is transmitted; referencing the storage location of the electronic data from a result of the analysis; judging whether or not the certificated user has an access right to the electronic data; judging, when it is judged that the user has the access right to the electronic data, whether or not unprotected electronic data can be transmitted; selecting, when it is judged that the unprotected electronic data can be transmitted, unprotected electronic data; selecting, when it is judged that the unprotected electronic data cannot be transmitted, protected electronic data; and transmitting the selected electronic data to the designated destination.

### BACKGROUND OF THE INVENTION

1. Field of the Invention

The present invention relates to a document transmission control method.

2. Related Background Art

Conventionally, an access right is set for electronic data of a generated document to be transmitted when the electronic data has been stored, but a limitation as to whether or not the electronic data of the document can be modified is not specified. The user at the transmission source selects electronic data which cannot be modified and transmits it to the destination, so that the user at the destination cannot modify the electronic data.

However, when the limitation as to whether or not the electronic data of the document can be modified is not specified, the user at the destination can always make a change on the document. This causes a problem in that, if the user at the destination modifies the document, the modified, incorrect document is transmitted as correct information.

Further, in the case where the electronic data itself is set inaccessible in order to prevent from being modified, there is a problem in that the electronic data cannot be browsed even when the electronic data is only allowed to be browsed.

Furthermore, in the case where the electronic data transmitted by a sender in accordance with the limitation as to whether or not the document can be modified is to be further transmitted to another destination, there is a possibility of erroneously transmitting the electronic data which can be modified to the destination where the user is only capable of browsing the data.

### SUMMARY OF THE INVENTION

The present invention has been made in order to solve the above-mentioned problems and accordingly has an object to provide a document transmission control method. According to an aspect of the present invention, there is provided a document transmission control method, including: a first step of analyzing image data in which information about a storage location of electronic data of a generated document and other document attribute information are embedded and identifying the storage location of the electronic data; a second step of performing user certification of a user who analyzes the image data; a third step of designating, after the electronic data of the document is identified in the first step, a destination to which the electronic data is transmitted; a fourth step of referencing the storage location of the electronic data from a result of the analysis in the first step; a fifth step of judging whether or not the user certificated in the second step has an access right to the electronic data; a sixth step of judging, when it is judged that the user has the access right to the electronic data in the fifth step, whether or not unprotected electronic data can be transmitted; a seventh step of selecting, when it is judged that the unprotected electronic data can be transmitted in the sixth step, unprotected electronic data for transmission data; an eighth step of selecting, when it is judged that the unprotected electronic data cannot be transmitted in the sixth step, protected electronic data for transmission data; and a ninth step of transmitting the electronic data selected in the seventh or eighth step to the destination designated in the third step.

According to the present invention, it is possible to appropriately and automatically transmit electronic data in accordance with a limitation on a right of a user at the transmission source or destination as to whether or not the user can modify a document. Therefore, an incorrect document on which the user at the destination modified can be prevented from being transmitted as correct information.

Also, it is possible to allow a user who is given a right to browse electronic data to only browse electronic data. Further, when the electronic data is transmitted by a sender in accordance with a right as to whether or not to modify a document, since the transmission of the electronic data is appropriately and automatically performed, it is possible to avoid erroneous transmission of electronic data which can be modified to a destination where the user is only capable of browsing electronic data.

### BRIEF DESCRIPTION OF THE DRAWINGS

FIG. 1 is a flowchart illustrative of an operation procedure of registering electronic data in a database with a client device used in a document transmission control method according to an embodiment of the present invention;

FIG. 2 is a flowchart illustrative of an operation procedure of transmitting electronic data with an image processing device used in the document transmission control method according to the embodiment of the present invention;

FIG. 3 is a block diagram showing a hardware configuration of the image processing device to which the document transmission control method according to the embodiment of the present invention is applied; and

FIG. 4 is a block diagram showing a hardware configuration of a system configured on a network to which the document transmission control method according to the embodiment of the present invention is applied.

### DESCRIPTION OF THE PREFERRED EMBODIMENTS

Hereinafter, an embodiment of the present invention will be described in detail with reference to the accompanying drawings.

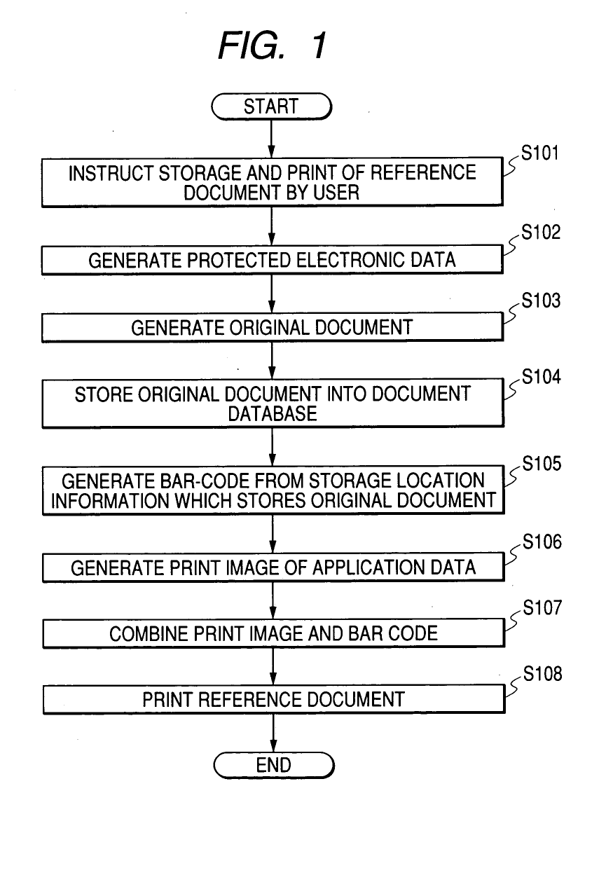

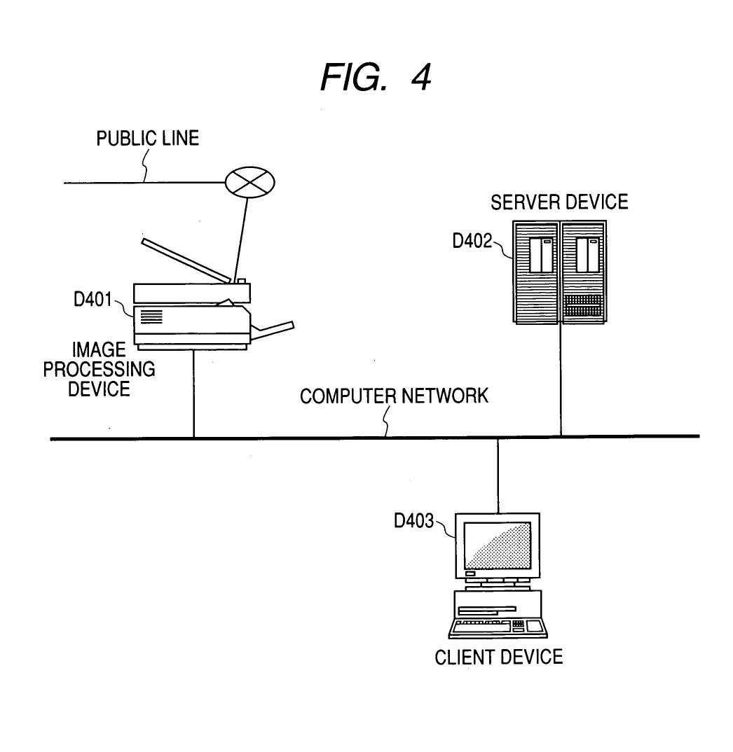

FIG. 1 is a flowchart illustrative of an operation flow of registering electronic data in a database with a client device (D403 in FIG. 4) used in a document transmission control method according to the embodiment of the present invention.

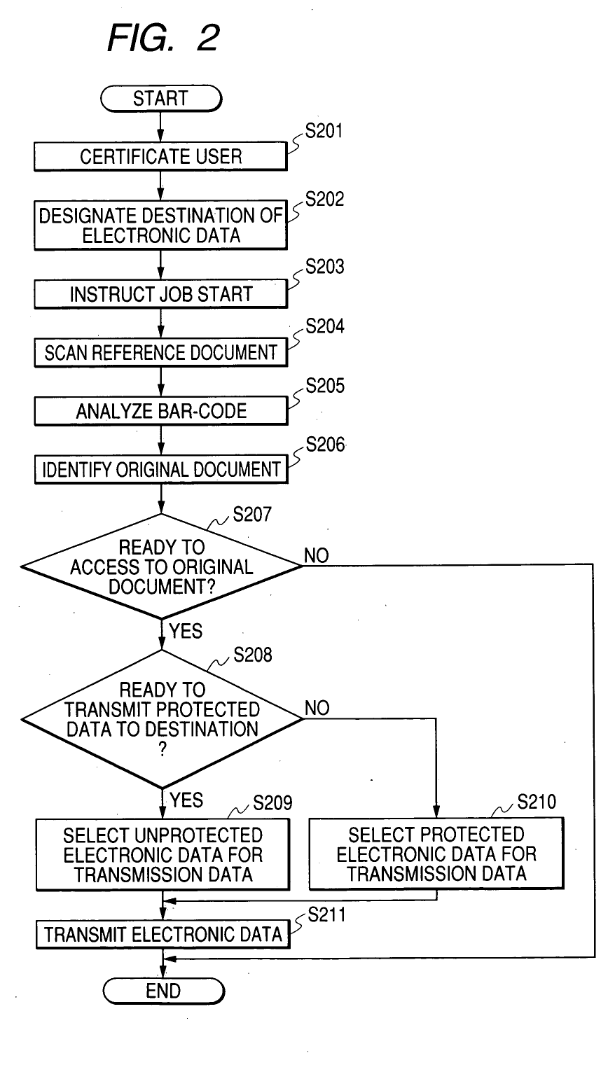

FIG. 2 is a flowchart illustrative of an operation flow of transmitting electronic data with an image processing device (D401 in FIG. 4) used in the document transmission control method according to the embodiment of the present invention.

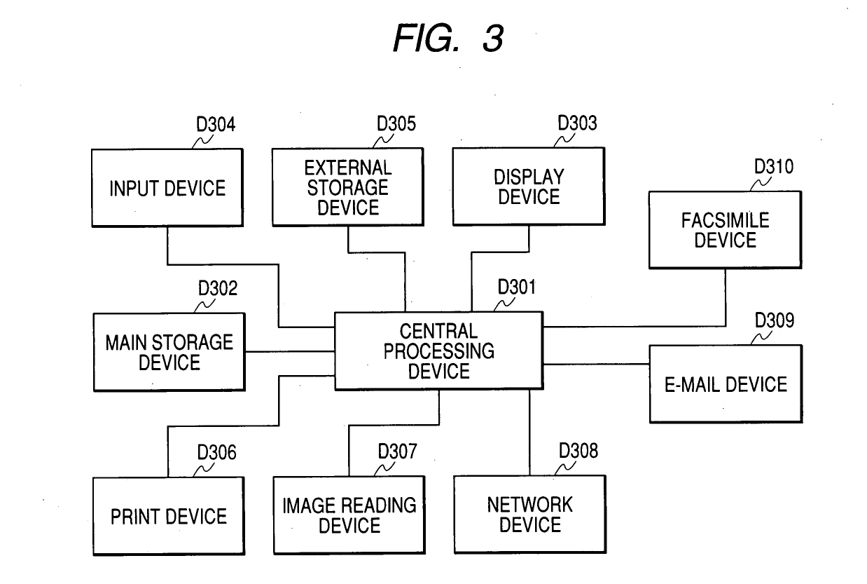

FIG. 3 is a block diagram showing a hardware configuration of the image processing device (D401) to which the document transmission control method according to the embodiment of the present invention is applied.

The image processing device (D401) has its main part composed of a central processing device (D301), a main storage device (D302), a display device (D303), an input device (D304), an external storage device (D305), a print device (D306), an image reading device (D307), a network device (D308), an e-mail device (D309), and a facsimile device (D310).

The central processing device (D301) controls the main storage device (D302), the display device (D303), the input device (D304), the external storage device (D305), the print device (D306), the image reading device (D307), the network device (D308), the e-mail device (D309), and the facsimile device (D310), and performs arithmetic operations and logical operations.

The main storage device (D302) stores information necessary for the image processing device to perform information processing, and the information can be retrieved as needed.

The display device (D303) displays a result of processing such as graphics or characters and can be a cathode-ray tube (CRT) display, a liquid crystal display, a touch panel display, or the like.

The input device (D304) is used for inputting various data to the central processing device (D301) and can be a keyboard, a mouse, a card reader, a touch panel, or the like.

The external storage device (D305) stores various types of information and can be a magnetic storage device, a magneto-optical storage device, or the like. In this embodiment, the external storage device (D305) is provided with a document database which stores electronic data of documents.

The print device (D306) prints the result of processing such as graphics or characters.

The image reading device (D307) converts paper original documents information to electronic information.

The network device (D308) is used for connecting a computer network to the image processing device (D401).

The e-mail device (D309) sends and receives an e-mail to and from any external device through the computer network. The facsimile device (D310) sends and receives a facsimile to and from any external device.

FIG. 4 is a block diagram showing a hardware configuration of a system configured on the network to which the document transmission control method according to the embodiment of the present invention is applied.

In this embodiment, electronic data of a document is stored, from the client device (D403), in the document database provided in the external storage device (D305) of the image processing device (D401). Further, a reference document which records document attribute information such as a storage location of the electronic data is output from the print device (D306) of the image processing device (D401).

The image processing device (D401) is used to analyze the document attribute information of the reference document. The electronic data of the document is printed at the print device (D306). Alternatively, the processing is performed such as transmission to a server device (D402) and transmission to a public line via the facsimile device (D310).

This embodiment will be explained in more detail below.

Operations of Registering Electronic Data in the Database

First, a user instructs that electronic data (hereinafter referred to as “application data”) of a generated document is stored, from the client device (D403), in the document database provided in the external storage device (D305) of the image processing device (D401), and the reference document which records the document attribute information including a storage location is output from the print device (D306) of the image processing device (D401) (step S101 in FIG. 1).

Next, protected electronic data, which cannot be modified, is generated from the application data stored in the document database (step S102). In this embodiment, a PDF format is used as a protected electronic data format (hereinafter, referred to as “PDF data”).

The application data generated by the user and the PDF data generated in step S102 are combined as one document (hereinafter, referred to as “original document”) (step S103) and the original document is stored in the document database (step S104).

Information about the storage location at which the generated original document is stored is generated as a bar code image (step S105). Further, a print image of the application data is generated (step S106).

The bar code image generated in step S105 and the print image generated in step S106 are combined to form a print image of the reference document (step S107). Then, the print image of the reference document is transmitted to the image processing device (D401) via the computer network and is printed with the print device (D306) (step S108).

Operations of Transmitting Electronic Data

First, a user undergoes user certification with the image processing device (D401) (step S201). In this embodiment, the user certification is carried out by inputting a user ID and password through the input device (D304).

Next, the user designates a destination of electronic data through the input device (D304) (step S202) and instructs to start a job of searching electronic data and transmitting the electronic data (step S203). In this embodiment, it is assumed that the data is transmitted to an e-mail address, aaa@canon.co.jp, as a destination.

The reference document printed in step S108 is scanned by the image reading device (D307) (step S204).

The bar code of the image scanned in step S204 is analyzed (step S205). In this embodiment, information regarding the storage location at which the original document is stored is analyzed and extracted, and the original document is identified from the extracted information (step S206).

Next, it is judged whether or not the user certificated in step S201 can access the original document identified in step S206 (step S207). When it is judged that the user cannot access the original document in step S207, the job is terminated.

In contrast, when it is judged that the user can access the original document in step S207, another judgment is made as to whether or not unprotected data, which can be modified, can be transmitted to the destination (step S208). When it is judged that the unprotected data can be transmitted in step S208, application data which is unprotected electronic data is selected from the original documents stored in the database in step S104 (step S209), and the selected application data is transmitted to the destination (step S211).

When it is judged that the unprotected data cannot be transmitted in step S208, PDF data, which is the protected electronic data, is selected from the original documents (step S210), and the selected PDF data is transmitted to the destination (step S211).

This application claims priority from Japanese Patent Application No. 2003-338297 filed Sep. 29, 2003, which is hereby incorporated by reference herein.

1. A document transmission control method, comprising:
a first step of analyzing image data in which information about a storage location of electronic data of a generated document and other document attribute information are embedded and identifying the storage location of the electronic data;
a second step of performing user certification of a user who analyzes the image data;
a third step of designating, after the electronic data of the document is identified in the first step, a destination to which the electronic data is transmitted;
a fourth step of referencing the storage location of the electronic data from a result of the analysis in the first step;
a fifth step of judging whether or not the user certificated in the second step has an access right to the electronic data;
a sixth step of judging, when it is judged that the user has the access right to the electronic data in the fifth step, whether or not unprotected electronic data can be transmitted;
a seventh step of selecting, when it is judged that the unprotected electronic data can be transmitted in the sixth step, unprotected electronic data for transmission data;
an eighth step of selecting, when it is judged that the unprotected electronic data cannot be transmitted in the sixth step, protected electronic data for transmission data; and
a ninth step of transmitting the electronic data selected in the seventh or eighth step to the destination designated in the third step.

2. A data transmission method, comprising:
a first step of judging whether or not an access right to data is provided;
a second step of judging whether or not modification can be made on the data; and
a controlling step of controlling handling of the data based on results of the first and second steps.

3. A data transmission method according to claim 2, wherein the controlling step includes:
allowing an access and modification to the data when the access right is provided and the data can be modified; and
allowing an access but not modification to the data when the access right is provided but the data cannot be modified.

4. A data transmission method according to claim 2, further comprising a step of transmitting data which is processed in accordance with a result of the second step.

5. A data transmission method according to claim 2, wherein:
the data is stored in a server on a network; and
the access right is used to control an access to the server or the data.

6. A storage medium, which stores a program causing a personal computer to execute the steps according to claim 2.

7. A system, comprising:
a server for storing data;
a client connected to the server via a network and accessing the data for data processing;
a first means for judging whether or not an access right to data is provided;
a second means for judging whether or not modification can be made on the data;
output means for outputting the data to the client via the network; and
control means for controlling an output operation of the output means.
